(19) United States
(12) Patent Application Publication
(10) Pub. No.: US 2015/0230185 A1
(43) Pub. Date: Aug. 13, 2015

(54) Low Noise Amplifier Device with Auxiliary Gain Control

(71) Applicant: QUALCOMM Incorporated, San Diego, CA (US)

(72) Inventors: Mohammad Bagher Vahid Far, San Jose, CA (US); Amirpouya Kavousian, San Jose, CA (US); Alireza Khalili, Sunnyvale, CA (US); Yashar Rajavi, Mountain View, CA (US)

(73) Assignee: QUALCOMM Incorporated, San Diego, CA (US)

(21) Appl. No.: 14/179,303

(22) Filed: Feb. 12, 2014

(51) Int. Cl. H04W 52/02

(52) U.S. Cl. CPC H04W 52/0274; H04W 52/0261

(57) ABSTRACT

An apparatus includes a main low noise amplifier and an auxiliary low noise amplifier. The auxiliary low noise amplifier is coupled in parallel with the main low noise amplifier. The auxiliary low noise amplifier includes a common source degeneration resistor.

### I. FIELD

The present disclosure is generally related to low noise amplifiers (LNAs).

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless telephones and other wireless devices may receive wireless signals using a receiver. The receiver may include a low noise amplifier (LNA) to amplify the signal to increase an amplitude of the signal. The LNA may be configured to improve signal quality by amplifying one or more components of the received signal (e.g., the transmitted signal) without substantially amplifying other portions of the received signal, such as noise. However, LNAs may consume a significant amount of power, which reduces battery life of a wireless device.

### III. BRIEF DESCRIPTION OF THE DRAWINGS

FIG. 1 shows a wireless device communicating with a wireless system;

FIG. 2 shows a block diagram of the wireless device in FIG. 1;

FIG. 3 is a block diagram that depicts an exemplary embodiment of a system that may be included in the wireless device of FIG. 1;

FIG. 4 is a diagram that depicts another exemplary embodiment of a system that may be included in the wireless device of FIG. 1; and

FIG. 5 is a flowchart that illustrates an exemplary embodiment of a method of operating a circuit that includes a main low noise amplifier and an auxiliary low noise amplifier, such as a circuit that may be included in the wireless device of FIG. 1.

### IV. DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

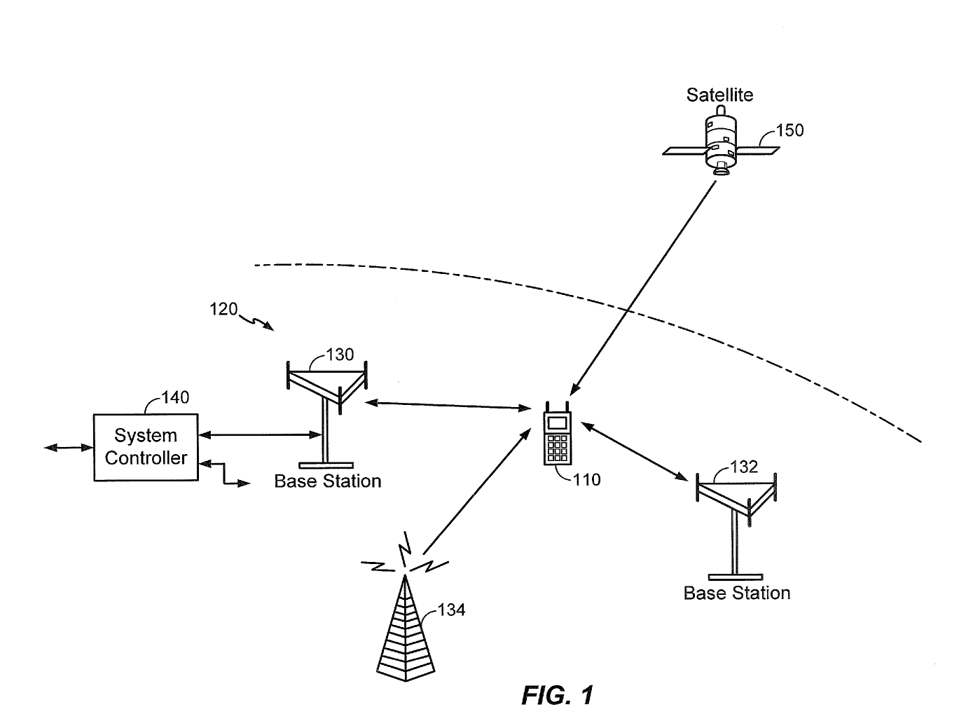

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

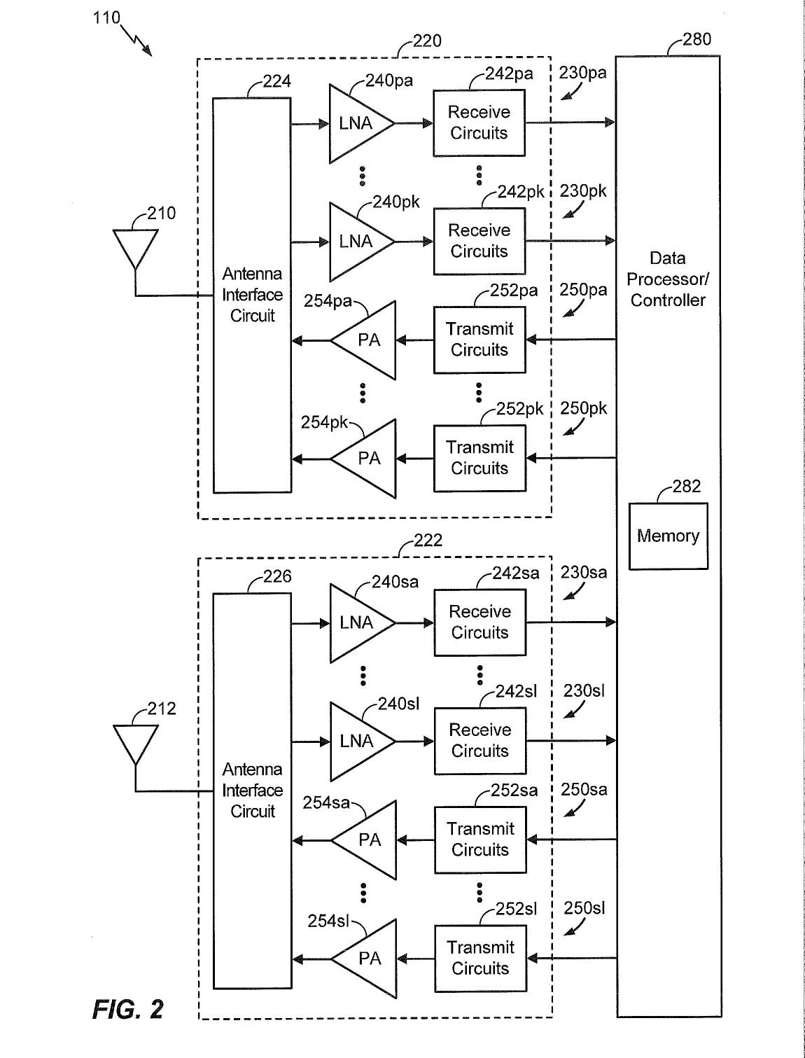

FIG. 2 shows a block diagram of an exemplary design of wireless device 110 in FIG. 1. In this exemplary design, wireless device 110 includes a transceiver 220 coupled to a primary antenna 210, a transceiver 222 coupled to a secondary antenna 212, and a data processor/controller 280. Transceiver 220 includes multiple (K) receivers 230pa to 230pk and multiple (K) transmitters 250pa to 250pk to support multiple frequency bands, multiple radio technologies, carrier aggregation, etc. Transceiver 222 includes multiple (L) receivers 230sa to 230s1 and multiple (L) transmitters 250sa to 250s1 to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes an LNA 240 and receive circuits 242. For data reception, antenna 210 receives signals from base stations and/or other transmitter stations and provides a received RF signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in similar manner as receiver 230pa.

In the exemplary design shown in FIG. 2, each transmitter 250 includes transmit circuits 252 and a power amplifier (PA) 254. For data transmission, data processor 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via antenna 210. Each remaining transmitter 250 in transceivers 220 and 222 may operate in similar manner as transmitter 250pa.

FIG. 2 shows an exemplary design of receiver 230 and transmitter 250. A receiver and a transmitter may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 may be implemented on one module, which may be an RFIC, etc. The circuits in transceivers 220 and 222 may also be implemented in other manners.

Data processor/controller 280 may perform various functions for wireless device 110. For example, data processor 280 may perform processing for data being received via receivers 230 and data being transmitted via transmitters 250. Controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

Wireless device 110 may support multiple band groups, multiple radio technologies, and/or multiple antennas. Wireless device 110 may include a number of LNAs to support reception via the multiple band groups, multiple radio technologies, and/or multiple antennas.

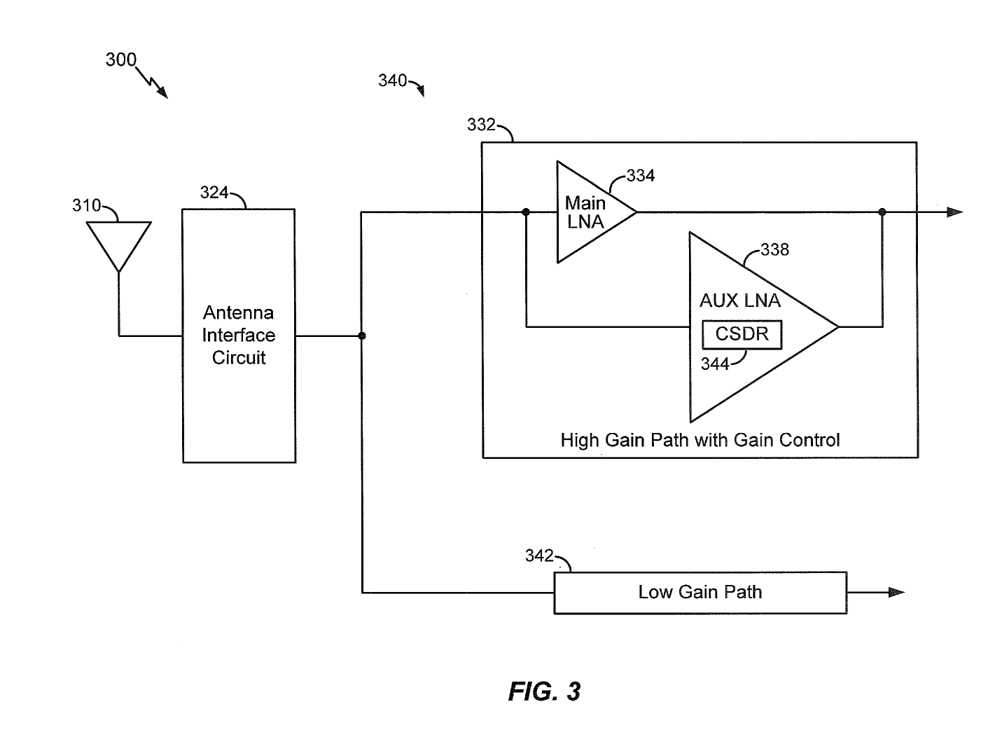

The wireless device 110 of FIGS. 1 and 2 illustrates an exemplary device that may include one or more LNAs in accordance with the present disclosure. As described further with reference to FIGS. 3-5, power consumption and response linearity of the wireless device 110 may be improved using an auxiliary LNA having an adjustable gain.

Referring to FIG. 3, an exemplary embodiment of a system 300 is shown. The system 300 includes an antenna 310, an antenna interface circuit 324, and a low noise amplifier circuit 340. The system 300 may be implemented within a wireless device, such as the wireless device 110. For example, the antenna 310 may correspond to the antenna 210, the antenna interface circuit 324 may correspond to the antenna interface circuit 224, and the low noise amplifier circuit 340 may correspond to any of the LNAs 240.

Low noise amplifier devices with auxiliary gain control are disclosed herein. Low noise amplifiers may be used for various types of electronic devices, such as wireless communication devices. In an exemplary design, a low noise amplifier device includes a main low noise amplifier and an auxiliary low noise amplifier with gain control. The main low noise amplifier may include a degenerative inductor, and the auxiliary low noise amplifier may include common source degeneration resistors. By controlling a transconductance of the low noise amplifier device via the auxiliary low noise amplifier, the gain of the low noise amplifier device may be controlled in a power-efficient manner while improving linearity of response of the low noise amplifier device. A reflection coefficient (“S11”) and a noise figure may also be improved. For example, because the auxiliary low noise amplifier may be external to the main low noise amplifier, adjusting the transconductance of the low noise amplifier may not affect (or may have reduced impact on) performance (e.g., reflection coefficient and noise figure) of the main low noise amplifier.

The low noise amplifier circuit 340 may include a high gain path 332 and a low gain path 342. The high gain path 332 may include a main low noise amplifier (LNA) 334 and an auxiliary LNA 338 that is coupled in parallel with the main LNA 334. Because the main LNA 334 and the auxiliary LNA 338 are coupled in parallel in the example of FIG. 3, the main LNA 334 may draw a first portion of an input signal (e.g., a first current) during operation of the system 300, and the auxiliary LNA 338 may draw a second portion of the input signal (e.g., a second current) during operation of the system 300. The auxiliary LNA 338 may include common source degeneration resistors (CSDR) 344. The low gain path 342 may include an LNA, such as a low gain LNA (not shown in FIG. 3). The high gain path 332 may have a controllable gain. For example, a transconductance of the auxiliary LNA 338 may be controllable to adjust the gain of the high gain path 332.

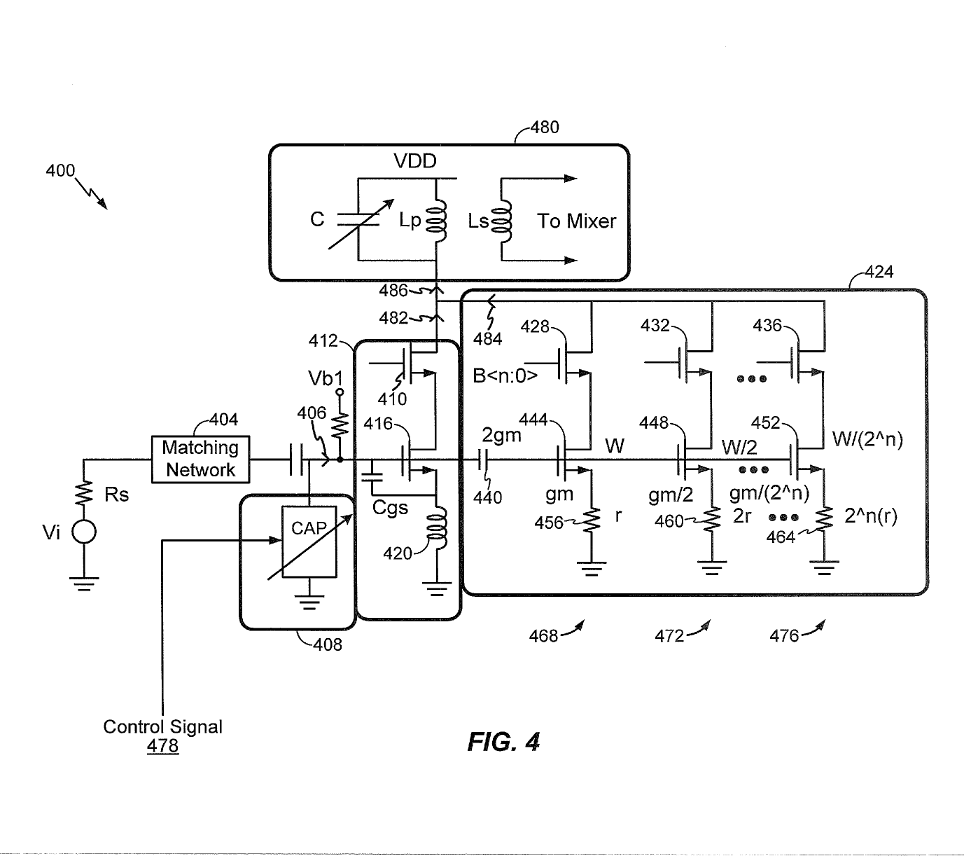

By using the auxiliary LNA 338 to adjust the gain of the high gain path 332, input sensitivity of the high gain path 332 can be controlled. For example, input sensitivity of the high gain path 332 can be controlled without substantially increasing a noise figure or a reflection coefficient of the high gain path 332. In an exemplary design, the gain of the high gain path 332 is controlled by selectively activating or deactivating branches including the common source degeneration resistors 344, as explained further with reference to FIG. 4.

Referring to FIG. 4, an exemplary embodiment of a system 400 is shown. The system 400 includes a matching network 404, a programmable capacitance (e.g., a programmable capacitor bank), a main low noise amplifier (LNA) 412, an auxiliary LNA 424, and a load 480. In an exemplary design, the system 400 of FIG. 4 is implemented within the high gain path 332 of FIG. 3. For example, the main LNA 412 may correspond to the main LNA 334, and the auxiliary LNA 424 may correspond to the auxiliary LNA 338.

The main LNA 412 may include a transistor 410, a main transistor 416, and an inductor 420, such as an inductive source degeneration (ISD) inductor that is coupled to a source terminal of the main transistor 416. In FIG. 4, the main LNA 412 is an ISD-configured LNA. For example, in FIG. 4, the main LNA 412 includes an inductive source degeneration circuit formed by the main transistor 416, the inductor 420, and a capacitor (or gate-to-source capacitance) (Cgs) associated with the main transistor 416.

The auxiliary LNA 424 may include a number (n) of branches (e.g., current source branches) that are each switchable to adjust a gain of the auxiliary LNA 424. To illustrate, FIG. 4 depicts that the auxiliary LNA 424 may include a branch 468 including a switch 428, a transistor 444, and a common source degeneration resistor 456. The auxiliary LNA 424 may further include a branch 472 including a switch 432, a transistor 448, and a common source degeneration resistor 460. The auxiliary LNA 424 may further include a branch 476 including a switch 436, a transistor 452, and a common source degeneration resistor 464. In the example of FIG. 4, n=3, although it should be appreciated that n may be any positive integer.

One or both of the main LNA 412 and the auxiliary LNA 424 may include cascode transistors. The transistor 410 and the main transistor 416 may form a first cascode pair of n-type metal-oxide-semiconductor field-effect transistors (nMOSFETs). The switch 428 and the transistor 444 may form a second cascode pair of nMOSFETs. The switch 432 and the transistor 448 may form a third cascode pair of nMOSFETS, and the switch 436 and the transistor 452 may form a fourth cascode pair of nMOSFETs.

In the example of FIG. 4, the transistors 444, 448, and 452 have binary weighted widths. To illustrate, FIG. 4 depicts that the transistor 444 may have a first width (w), the transistor 448 may have a second width (w/2), and the transistor 452 may have a third width (w/(2̂n)). Binary weighting of the widths of the transistors 444, 448, and 452 may enable binary weighting transconductance values of the branches 468, 472, and 476. In FIG. 4, the transistor 444 has a first transconductance value (gm), the transistor 448 has a second transconductance value (gm/2), and the third transistor 452 has a third transconductance value (gm/(2̂n)).

The common source degeneration resistors 456, 460, and 464 may have binary weighted resistance values. For example, FIG. 4 illustrates that the common source degeneration resistor 456 may have a first resistance value (r). The common source degeneration resistor 460 may have a second resistance value (2r), and the common source degeneration resistor 464 may have a third resistance value ((2̂n)r).

The resistance values of the common source degeneration resistors 456, 460, and 464 may correspond to the widths of a set of transistors, such as the transistors 444, 448, and 452. To illustrate, the first resistance value (r) of the common source degeneration resistor 456 may correspond to the first width (w) of the transistor 444, and the second resistance value (2r) of the common source degeneration resistor 460 may correspond to the second width (w/2) of the transistor 448. In this example, a first ratio of the second resistance value to the first resistance value (i.e., 2r/r=2) matches (e.g., is approximately equal to) a second ratio of the first width to the second width (i.e., w/(w/2)=2). Maintaining a ratio between resistance values and transistor widths in such a manner may improve response linearity of the system 400 for a range of gains of the system 400, such as a range of gains that may be implemented using activation and deactivation of the switches 428, 432, and 436.

The main LNA 412 and the auxiliary LNA 424 may be coupled in parallel, as illustrated in FIG. 4. In the example of FIG. 4, the main LNA 412 and the auxiliary LNA 424 are coupled via an alternating current (AC) coupling (e.g., via a capacitor 440). The capacitor 440 may be associated with a transconductance value 2 gm. It will be appreciated that the main LNA 412 and the auxiliary LNA 424 may be coupled via another coupling, such as a direct current (DC) coupling, without departing from the scope of the present disclosure. As an example, the main LNA 412 and the auxiliary LNA 424 may be DC-coupled via a node. The node may be coupled to a first terminal of a capacitor, and a second terminal of the capacitor may be coupled to ground.

In operation, the system 400 may receive an input signal to be amplified. In the example of FIG. 4, the input signal is illustrated as a voltage source (Vi) and an equivalent series resistance (Rs). The matching network 404 is responsive to the input signal. The matching network 404 may be configured to adjust an input impedance of the system 400 to correspond to the equivalent series resistance. The matching network 404 may output a signal 406. The signal 406 may be biased using a bias voltage (Vbl), as illustrated in the example of FIG. 4.

The main LNA 412 and the auxiliary LNA 424 are responsive to the signal 406. Because the main LNA 412 and the auxiliary LNA 424 are coupled in parallel in the example of FIG. 4, the main LNA 412 may draw a first portion of the signal 406 (e.g., a first current), and the auxiliary LNA 424 may draw a second portion of the signal 406 (e.g., a second current) when one or more of the branches 468, 472, and 476 are activated.

The main LNA 412 may amplify the signal 406 to generate a signal 482. The main LNA 412 may amplify the signal 406 in accordance with an inductive source degeneration (ISD) effect using the inductor 420. For example, the inductor 420 may have an inductance that reduces a reflection coefficient and noise figure associated with the system 400 during operation of the main LNA 412.

The auxiliary LNA 424 may have a gain that is adjustable via a multi-bit digital code (B<n:0>). For example, the switches 428, 432, and 436 may each be responsive to a respective bit of the multi-bit digital code. The switches 428, 432, and 436 may be selectively activated or deactivated based on logical values of the multi-bit digital code. To illustrate, the switch 428 may be activated based on a first logical value (e.g., a logical “1” value) of a first bit of the multi-bit digital code, and the switch 428 may be deactivated based on a second logical value (e.g., a logical “0” value) of the first bit of the multi-bit digital code. The switch 432 may be activated based on a first logical value (e.g., a logical “1” value) of a second bit of the multi-bit digital code, and the switch 432 may be deactivated based on a second logical value (e.g., a logical “0” value) of the second bit of the multi-bit digital code. The switch 436 may be activated based on a first logical value (e.g., a logical “1” value) of an nth bit of the multi-bit digital code, and the switch 436 may be deactivated based on a second logical value (e.g., a logical “0” value) of the nth bit of the multi-bit digital code.

The transistors 444, 448, and 452 may be responsive to the signal 406 via the capacitor 440. Alternatively or in addition, the transistors 444, 448, and 452 may be responsive to the signal 406 via another coupling, such as a DC coupling. The transistors 444, 448, and 452 may amplify the signal 406 and the amount of amplification is based on which of the switches 428, 432, 436 are activated by the multi-bit digital code.

To illustrate, if the switch 428 is activated by a bit of the multi-bit digital code, the transistor 444 may have an “on” state and may generate a signal 484 responsive to the signal 406. If the switch 428 is deactivated by the bit of the multi-bit digital code, a drain terminal of the transistor 444 may be unbiased, and the transistor 444 may have an “off” state. In this case, the branch 468 may be “off.”

Selectively activating and/or deactivating the switches 428, 432, and 436 adjusts a gain of the auxiliary LNA 424. For example, by activating the switch 428, the transistor 444 is enabled to amplify a portion of the signal 406. The transistor 444 is associated with the first transconductance value (gm), which contributes to a gain of the auxiliary LNA 424. Therefore, the gain of the auxiliary LNA 424 may be adjusted by activating or deactivating the switch 428. Similarly, the gain of the auxiliary LNA 424 (and of the system 400) may be adjusted by activating or deactivating the switches 432, 436.

Both the main LNA 412 and the auxiliary LNA 424 may contribute to an overall gain of the system 400. To illustrate, in an exemplary design, the main LNA 412 has a “fixed” or substantially fixed gain, and the auxiliary LNA 424 has a gain that can be adjusted dynamically (or “on-the-fly”) to compensate for signal quality of received signals, such as based on a change in a signal-to-noise ratio (SNR) of received signals. For example, while a received signal has a high SNR, the gain of the system 400 may be reduced via the auxiliary LNA 424 to conserve power and to reduce sensitivity of the main LNA 412. If the SNR of the received signal decreases, the gain of the system 400 may be increased via the auxiliary LNA 424 to amplify the received signal to a level within a range suitable for processing by other device components.

The gain of the main LNA 412 may determine a magnitude of a reflection coefficient associated with the system 400. Adjusting the gain of the auxiliary LNA 424 may affect an imaginary portion of the reflection coefficient associated with the system 400, which may change a capacitance of the system 400. The programmable capacitance 408 may be adjusted to compensate for the change in capacitance of the system 400 caused by adjusting the gain of the auxiliary LNA 424. To illustrate, the programmable capacitance 408 may include a programmable capacitor bank that is coupled to the main LNA 412. A capacitance value of the programmable capacitor bank may be programmable to offset variations in capacitance in the auxiliary LNA 424 caused by activating or deactivating one or more of the branches 468, 472, and 476 of the auxiliary LNA 424. The programmable capacitance 408 may be responsive to the control signal 478. The control signal 478 may be a multi-bit digital code with multiple bits to adjust a capacitance of the programmable capacitance 408. For example, the programmable capacitance 408 may include a plurality of capacitors coupled to a plurality of switches. Each of the switches may be activated or deactivated by a corresponding bit of the control signal 478 to enable or disable a corresponding capacitor of the plurality of capacitors.

In an exemplary implementation, the control signal 478 corresponds to a logical complement of the multi-bit digital code (B<n:0>). For example, if the multi-bit digital code (B<n:0>) includes bits (b0, b1, . . . bn) that control the switches 428, 432, and 436, the system 400 may include logic to invert the multi-bit digital code (B<n:0>) to generate inverted bits (b0′, b1′, . . . bn′). The logic may include one or more inverters, such as one or more complementary metal-oxide-semiconductor (CMOS) inverters. The control signal 478 may include the inverted bits, and the programmable capacitance 408 may include a plurality of switches responsive to the inverted bits to activate or deactivate respective capacitors of the programmable capacitance 408. The capacitance of the programmable capacitance 408 may be adjusted upon selectively activating one or more of the branches 468, 472, and 476. Alternatively, the capacitance of the programmable capacitance 408 may be adjusted concurrently with, substantially concurrently with, or prior to activating the one or more branches 468, 472, and 476.

The signals 482, 484 may be summed at a node of the system 400 to generate a signal 486. The node may correspond to an input node of the load 480 and an output node of the main LNA 412 and the auxiliary LNA 424. It will be appreciated that the polarity of the signals 482, 484, and 486 may depend on the application (e.g., the signals 482, 484, and 486 illustrated in FIG. 4 may correspond to positive or negative current magnitudes depending on the application). The load 480 may be magnetically coupled to one or more other device components, such as to a mixer stage of the wireless device 110. The load 480 may be configured to transfer amplified signals to other device components, such as to a mixer. In the example of FIG. 4, the load includes a primary inductor (Lp) magnetically coupled to a secondary inductor (Ls). The load 480 may be responsive to a supply voltage (VDD) and may include a programmable capacitor (C) that is programmable to adjust a response of the load 480 (e.g., to filter particular frequencies of the signal 486 and/or to tune a frequency response of the load 480 based on a resonant frequency).

The system 400 of FIG. 4 enables power-efficient gain control and linearity of an ISD-configured LNA without substantially degrading noise figure and reflection coefficient parameters. To illustrate, ISD-configured LNAs may be associated with sensitive input stages and high gain levels. Certain conventional devices use an attenuator (or “bleeder”) for gain reduction of an ISD-configured LNA by discharging current to ground. In some cases, such a design may result in high power consumption, non-linear device response to input signals, and/or degradation of noise figure. Other devices may use a switchable device at an input of an ISD-configured LNA to adjust a transconductance at an input of the ISD-configured LNA. Adjusting a transconductance at the input of an ISD-configured LNA may alter an impedance of the ISD-configured LNA, possibly resulting in impedance mismatch between device components that increases the reflection coefficient. Using an auxiliary LNA and programmable capacitance as described with reference to FIG. 4 enables gain reduction of an LNA while also improving power efficiency, linearity of device response over a range of gains, noise figure, and reflection coefficient as compared to other LNA designs.

To further illustrate, the system 400 may be associated with a noise figure, a third order intercept point (IIP3), and a reflection coefficient parameter that are to be satisfied. Each of the branches 468, 472, and 476 may be associated with a corresponding transconductance (gm). If a number (n) indicates a number of branches of the auxiliary LNA 424, then an overall gain (Gm) may be determined by Gm=n*gm. In this example, n branches in parallel may be used to achieve the gain Gm, which may improve performance of the system 400 in certain conditions. However, use of n parallel branches may be associated with an increased current consumption (n*I0 where I0 is a current through a single branch) and a decreased effective inductance (Id/n where Id is an inductance of the inductor 420) of the inductor 420. Decreasing the effective inductance may increase LNA sensitivity of the system 400 and may increase parasitic effects of the inductor 420.

Accordingly, in an exemplary design, for an overall gain (Gm) of the main LNA 412 and the auxiliary LNA 424, the main LNA 412 may be configured to provide a first portion of the overall gain, such as k*Gm of gain (e.g., current gain), where 0<k<1. The auxiliary LNA 424 may be of a common source degeneration configuration that uses common source degeneration resistors to provide a second portion of the overall gain, such as (1−k)*Gm of gain (e.g., current gain), while satisfying the IIP3 parameter. The auxiliary LNA 338 may be of a modular configuration and may be programmable using cascode devices, such as the second, third, and/or fourth cascode pairs of transistors described with reference to FIG. 4. In such an exemplary design, the auxiliary LNA 424 may not affect the transconductance parameters gin that contribute to an input impedance of the main LNA 412 (and that satisfy the reflection coefficient). Effects of the auxiliary LNA 424 on the “main” amplification path (e.g., the path through the main LNA 412 to the load 480) may be compensated for by adjusting (or “fine-tuning”) the programmable capacitance 408. To further illustrate, while one or more branches of the auxiliary LNA 424 are activated, an input impedance (Zin) of the main LNA 412 may be Zin=rd+1/(SCg1)+gm1*(rd/(SCg1)=rd+(1+gm*rd)/(SCg1), where rd indicates a degenerative resistance of the auxiliary LNA 424, where S indicates a block loss parameter associated with the system 400, and where Cg1 indicates a gate-to-source capacitance associated with the system 400. While each branch of the auxiliary LNA 424 is deactivated, the input impedance of the main LNA 412 may be given by Zin=rd+1/(SCg1). Thus, the impedance difference between the two equations (i.e., due to the term (1+gm*rd)) may be compensated for by adjusting the programmable capacitance 408. In this manner, a noise figure of the system 400 may be maintained at a value (GO) while also providing gain. Further, power consumption is reduced and IIP3 is improved in different gain modes (e.g., when gain is reduced) as compared to conventional devices.

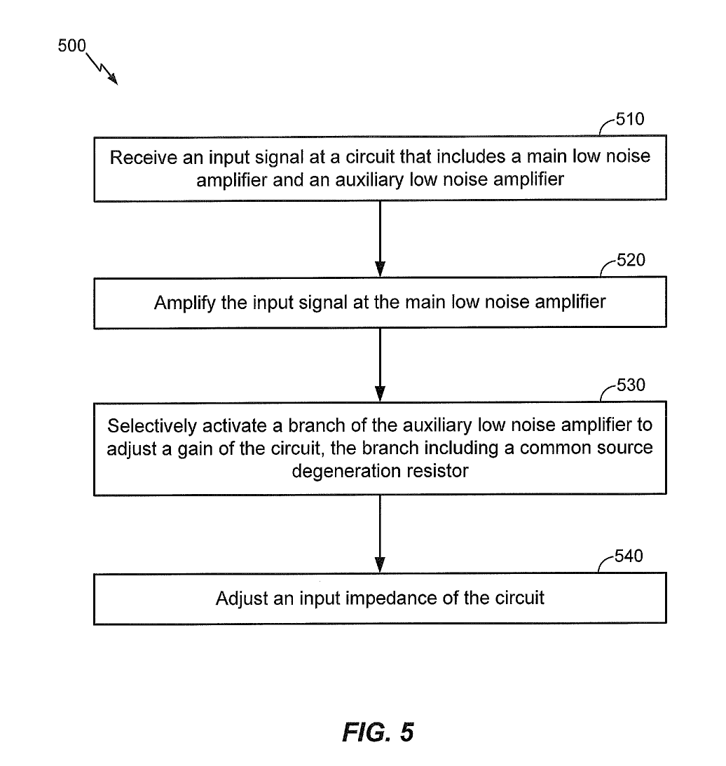

Referring to FIG. 5, a flowchart that illustrates an exemplary embodiment of a method of operating a circuit that includes a main low noise amplifier and an auxiliary low noise amplifier is shown and generally designated 500. In an illustrative embodiment, the method 500 may be performed at the wireless device 110 of FIGS. 1-2, the system 300 of FIG. 3, the system 400 of FIG. 4, or any combination thereof.

The method 500 may include receiving an input signal at a circuit that includes a main low noise amplifier and an auxiliary low noise amplifier, at 510. The circuit may include the system 300, the system 400, or a combination thereof. The main low noise amplifier may correspond to the main LNA 334, the main LNA 412, or a combination thereof. The auxiliary low noise amplifier may correspond to the auxiliary LNA 338, the auxiliary LNA 424, or a combination thereof. The input signal may correspond to the signal 406.

The method 500 may also include amplifying the input signal at the main low noise amplifier, at 520. The method 500 may include selectively activating a branch of the auxiliary low noise amplifier to adjust a gain of the circuit, at 530. The branch includes a common source degeneration resistor. The branch may correspond to any of the branches 468, 472, and 476. The common source degeneration resistor may correspond to one of the common source degeneration resistors 344, 456, 460, and 464.

The method 500 may also include adjusting an input impedance of the circuit, at 540. For example, the input impedance may be adjusted by programming the programmable capacitance 408 using the control signal 478 in response to selectively activating the branch. Alternatively, the input impedance of the circuit may be adjusted concurrently with, substantially concurrently with, or prior to activating the branch.

The method 500 may enable gain control at a low noise amplifier device while also improving noise figure and reflection coefficient. For example, by adjusting a gain of the low noise amplifier device via the auxiliary low noise amplifier, the gain of the low noise amplifier device may be controlled in a power-efficient manner while improving linearity of response of the low noise amplifier device as well as improving reflection coefficient and noise figure. In this manner, gain of the low noise amplifier device can be reduced while also reducing power consumption, as compared to devices that reduce gain by sinking (or “bleeding”) current to ground.

In conjunction with the described embodiments, an apparatus includes means for amplifying a first portion of an input signal. The means for amplifying the first portion of the input signal may correspond to the main LNA 334, the main LNA 412, or a combination thereof. The input signal may correspond to the signal 406. The first portion of the input signal may correspond to a portion of the signal 406 drawn by the main LNA 412.

The apparatus may further include means for amplifying a second portion of the input signal by steering current away from one or more common source degeneration resistors. The means for amplifying a second portion of the input signal may correspond to the auxiliary LNA 338, the auxiliary LNA 424, or a combination thereof. The one or more common source degeneration resistors may correspond to any of the common source degeneration resistors 344, 456, 460, and 464. The second portion of the input signal may correspond to a portion of the signal 406 drawn by the auxiliary LNA 424.

As used herein, “matching” (e.g., matching of impedances) refers to a substantial or approximate matching that one of skill in the art would recognize as facilitating proper device properties based on the application. For example, “matched” impedances, component dimensions, and/or ratios need not be exactly equal. Rather, those of skill in the art will recognize that “matched” impedances, component dimensions, and/or ratios may vary within a tolerance that depends on the application and that achieves particular device properties.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. For example, the control signal 478 and/or the multi-bit digital code (B<n:0>) of FIG. 4 may be generated by a processor that executes instructions. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. To illustrate, a processor may execute instructions to perform a method or algorithm that includes generating the control signal 478 and/or the multi-bit digital code (B<n:0>) of FIG. 4. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. For example, although certain exemplary circuits have been described, other circuits can be implemented. Thus, the present disclosure is not intended to be limited to the embodiments shown herein but is to be accorded the widest scope possible consistent with the principles and novel features as defined by the following claims.

What is claimed is:

1. An apparatus comprising:
a main low noise amplifier; and
an auxiliary low noise amplifier coupled in parallel with the main low noise amplifier, the auxiliary low noise amplifier comprising a common source degeneration resistor.

2. The apparatus of claim 1, wherein the main low noise amplifier comprises an inductive source degeneration low noise amplifier.

3. The apparatus of claim 1, wherein a gain of the auxiliary low noise amplifier is adjustable based on a control signal.

4. The apparatus of claim 3, wherein the control signal is a multi-bit digital code, and wherein the auxiliary low noise amplifier includes switches responsive to the multi-bit digital code.

5. The apparatus of claim 3, further comprising a programmable capacitor bank coupled to the main low noise amplifier.

6. The apparatus of claim 1, wherein the main low noise amplifier and the auxiliary low noise amplifier have an overall gain, wherein the main low noise amplifier is configured to provide a first portion of the overall gain, and wherein the auxiliary low noise amplifier is configured to provide a second portion of the overall gain.

7. The apparatus of claim 1, wherein the common source degeneration resistors have resistance values that correspond to widths of a set of transistors of the auxiliary low noise amplifier.

8. The apparatus of claim 7, wherein a first common source degeneration resistor of the common source degeneration resistors has a first resistance value that corresponds to a first width of a first transistor of the set of transistors.

9. The apparatus of claim 8, wherein a second common source degeneration resistor of the common source degeneration resistors has a second resistance value that corresponds to a second width of a second transistor of the set of transistors.

10. The apparatus of claim 9, wherein a first ratio of the second resistance value to the first resistance value matches a second ratio of the first width to the second width.

11. An apparatus comprising:
means for amplifying a first portion of an input signal; and
means for amplifying a second portion of the input signal using a common source degeneration resistor.

12. The apparatus of claim 11, wherein the means for amplifying the first portion of the input signal includes a main low noise amplifier.

13. The apparatus of claim 11, wherein the means for amplifying the second portion of the input signal includes an auxiliary low noise amplifier.

14. The apparatus of claim 13, wherein the auxiliary low noise amplifier includes the common source degeneration resistor.

15. The apparatus of claim 11, further comprising means for adjusting an input impedance of the means for amplifying the first portion of the input signal.

16. The apparatus of claim 15, wherein the means for adjusting the input impedance includes a programmable capacitance that is responsive to a control signal.

17. A method of operating a circuit that includes a main low noise amplifier and an auxiliary low noise amplifier, the method comprising:
amplifying an input signal at the main low noise amplifier; and
selectively activating a branch of the auxiliary low noise amplifier to adjust a gain of the circuit, the branch including a common source degeneration resistor.

18. The method of claim 17, further comprising adjusting an input impedance of the circuit based on selectively activating the branch.

19. The method of claim 18, wherein the input impedance of the circuit is adjusted by programming a capacitance of a programmable capacitor bank to offset a variation in capacitance of the auxiliary low noise amplifier caused by activating the branch.

20. The method of claim 17, further comprising selectively activating a switch of the auxiliary low noise amplifier to activate the branch.
